(19) United States
(12) Patent Application Publication
(10) Pub. No.: US 2006/0262081 A1
(43) Pub. Date: Nov. 23, 2006

(54) Electrophoretic display device

(76) Inventors: Guofu Zhou, Eindhoven (NL); Peter Alexander Duine, Eindhoven (NL); Rogier Hendrikus Magdalena Cortie, Eindhoven (NL); Mark Thomas Johnson, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/555,265

(22) PCT Filed: May 3, 2004
(86) PCT No.: PCT/IB04/50562

§ 371 Date: Nov. 1, 2005

(30) Foreign Application Priority Data
May 5, 2003 (EP) 03101242.0

(51) Int. Cl. G09G 3/34

(52) U.S. Cl. 345/107

(57) ABSTRACT

A display device comprises electrophoretic particles, a display element comprising a pixel electrode and a counter electrode between which a portion of the electrophoretic particles are present and a controller for supplying a drive signal to the electrodes to bring the display element in a predetermined black or white state, corresponding to the image information to be displayed. In order to improve the refresh time of the display, the controller is further arranged for supplying a preset signal preceding the drive signal comprising a preset pulse having an energy sufficient to release the electrophoretic particles at a first position near one of the two electrodes corresponding to a black state, but too low to enable the particles to reach a second position near the other electrode corresponding to a white state. The duration of the preset pulses is less than 19 msec, preferably between 1 and 10 msec. Setting the duration of the preset pulses to less than 19 msec reduced visible flicker F.

The invention relates to a display device as defined in the pre-characterising part of Claim 1.

Display devices of this type are used in, for example, monitors, laptop computers, personal digital assistants (PDA's), mobile telephones, electronic books, electronic newspapers, electronic magazines.

A display device of the type mentioned in the opening paragraph is known from the international patent application WO 99/53373. This patent application discloses a electronic ink display comprising two substrates, one of which is transparent, the other substrate is provided with electrodes arranged in row and columns. A crossing between a row and a column electrode is associated with a display element. The display element is coupled to the column electrode via a thin film transistor (TFT), the gate of which is coupled to the row electrode. This arrangements of display elements, TFT transistors and row and column electrode together forms an active matrix. Furthermore, the display element comprises a pixel electrode. A row driver selects a row of display elements and the column driver supply a data signal to the selected row of display elements via the column electrodes and the TFT transistors. The data signals corresponds to graphic data to be displayed.

Furthermore, an electronic ink is provided between the pixel electrode and a common electrode provided on the transparent substrate. The electronic ink comprises multiple microcapsules, of about 10 to 50 microns. Each microcapsule comprises positively charged white particles and negative charge black particles suspended in a fluid. When a positive field is applied to the pixel electrode, the white particles move to the side of the micro capsule directed to the transparent substrate and the display element become visible to a viewer. Simultaneously, the black particles move to the pixel electrode at the opposite side of the microcapsule where they are hidden to the viewer. By applying a negative field to the pixel electrode, the black particles move to the common electrode at the side of the micro capsule directed to the transparent substrate and the display element appears dark to a viewer. When the electric field is removed the display device remains in the acquired state and exhibit a bi-stable character.

Grey scales can be created in the display device by controlling the amount of particles that move to counter electrode at the top of the microcapsules. For example, the energy of the positive or negative electric field, defined as the product of field strength and time of application, controls the amount of particles moving to the top of the microcapsules.

The known display devices exhibit a so called dwell time. The dwell time is defined as the interval between a previous image update and a new image update.

A disadvantage of the present display is that it exhibits an underdrive effect which lead to inaccurate grey scale reproduction. This underdrive effect occurs, for example, when an initial state of the display device is black and the display is periodically switched between the white and black state. For example, after a dwell time of several seconds, the display device is switched to white by applying a negative field for an interval of 200 ms. In a next subsequent interval no electric field is applied for 200 ms and the display remains white and in a next subsequent interval a positive field is applied for 200 ms and the display is switched to black. The brightness of the display as a response of the first pulse of the series is below the desired maximum brightness, which can be reproduced several pulses later.

It is an object of the invention to provide a display device of the type mentioned in the opening paragraph which can be applied to improve the reproduction of grey scales.

To achieve this object, a first aspect of the invention provides a display device as specified in Claim 1.

The invention is based on the recognition that the optical response depends on the history of the display element. The inventors have observed that when a preset signal is supplied before the drive signal to the pixel electrode, which preset signal comprising a pulse with an energy sufficient to release the electrophoretic particle from a static state at one of the two electrodes, but too low too reach the other one of the electrodes, the underdrive effect is reduced. Because of the reduced underdrive effect the optical response to an identical data signal will be substantially equal, regardless of the history of the display device and in particular its dwell time. The underlying mechanism can be explained because after the display device is switched to a predetermined state e.g. a black state, the electrophoretic particles become in a static state, when a subsequent switching is to the white state, a momentum of the particles is low because their starting speed is close to zero. This results in a long switching time. The application of the preset pulses increases the momentum of the electrophoretic particles and thus shortens the switching time. It is also possible that after the display device is switched to a predetermined state e.g. a black state, the electrophoretic particles are “frozen” by the opposite ions surrounding the particle. When a subsequent switching is to the white state, these opposite ions have to be timely released, which requires additional time. The application of the preset pulses speeds up the release of the opposite ions thus the de-freezing of the electrophoretic particles and therefore shortens the switching time.

A further advantage is that the application of the preset pulses substantially eliminates a prior history of the electronic ink, whereas in contrast conventional electronic ink display devices requires massive signal processing circuits for the generation of data pulses of a new frame, storage of several previous frames and a large look-up table.

The inventors have realized during application of preset pulses, the so-called preset time, a fluctuation of the grey level (flicker) may occur. This flicker may become visible to the viewer. By using a preset pulse of less than 19 msec, the grey level fluctations are kept relatively small.

Within the concept of the invention it is possible that a set of preset pulses is applied and that some preset pulses, in particular the first or first few of a set of preset pulses are longer than 19 msec. The grey scale variation effect increases, when a set of preset pulses is used, as more pulses are given, i.e. the effect is stronger for the second pulse than for the first, for the third stronger than for the second etc. Therefore, some earlier pulses may be longer than 19 msec.

However, preferably the majority of preset pulses, most preferably all preset pulses are less than 19 msec to further reduce the grey level variations.

Preferably the preset pulses are longer than 0.5 msec. The preset pulses are meant to “shake up” the electrophoretic particles, when the length of the preset pulses decreases to smaller than 0.5 msec, the height of the preset voltage pulse has to be increased to a level that is difficult to obtain and sustain. Also as the pulse width decreases the energy consumption increases. Preferably the preset pulse width lies between 1 and 15 msec, most preferebaly between 2 and 10, even more preferably between 3 and 5 msec. The inventors have realized that a balance is best stuck between on the one hand the power requirement (as the pulse width decreases the power required increases), and the pulse height (as the pulse width decreases the pulse height increases) and on the other hand the optical effect (as the pulse width decreases the grey level variations decrease). Depending on the circumstances an optimum is obtained between 1 and 15 msec, where the best choice lies between 2 and 10, best between 3 and 5 msec.

Further advantageous embodiments of the invention are specified in the dependent claims.

In an embodiment the power dissipation of the display device can be minimised by applying just a single preset pulse.

In an embodiment a preset signal consisting of an even number of preset pulses of opposite polarity can be generated for minimising the DC component and the visibility of the preset pulses of the display device. Two preset pulses, one with positive polarity and one with negative polarity will minimize the power dissipation of the display device within this mode of operation Preferably both of these pulses have a duration of less than 19 msec, preferably both being within the specified preferred range of larger than 0.5 msec, within 1 and 15, respectively within 2 and 10, respectively within 3 and 5 msec.

In an embodiment the electrodes are arranged to form a passive matrix display.

In an embodiment the display device is provided with an active matrix addressing to provide the data signals to the pixel electrodes of the display elements.

In an embodiment the display elements are interconnected in two or more groups whereby preset pulses having a different polarity are supplied to the different parts of the screen. For example, when in a single frame addressing period the preset pulses are applied with a positive polarity to all even rows and a negative polarity to all odd rows adjacent rows of the display device will appear alternately brighter and darker and in the subsequent frame addressing period the positive and negative polarities of the preset pulses are inverted, the perceptual appearance will then hardly be effected, as the eye integrates these short brightness fluctuations both across the display (spatial integration) and over subsequent frames (temporal averaging). This principle is similar to the line inversion principle in methods for driving liquid crystal displays with reduced flicker.

In an embodiment the preset signals are generated in the second driving means and applied to the pixel electrodes simultaneously by selecting, for example, all even followed by all odd rows at a time by the first driving means. This embodiment requires no additional electronics on the substrates.

In an embodiment the preset signals are applied directly via the counter electrode to the pixel electrode. An advantage of this arrangement is that the power consumption is lower because the capacitance involved in this case is lower than in a case were the row or column electrodes are addressed.

In an embodiment the counter electrode is divided in several portions, in order to reduce the visibility of the preset pulses.

In an embodiment the pixel electrode is coupled via a first additional capacitive element. The voltage pulses on the pixel electrode can now be defined as the ratio of a pixel capacitance and the first additional capacitive element. The pixel capacitance is the intrinsic capacitance of the material between the pixel electrode and the transparent substrate. Particularly, in combination with an encapsulated electrophoretic material as supplied by E-Ink Corporation, this embodiment can be advantageous because in case the first additional capacitive element is selected to have a large value compared to the pixel capacitance, the preset signal will substantially be transmitted to the pixel electrode, which reduces the power consumption.

Furthermore, the pixel capacitance will not vary significantly with the different applied grey levels. Thus, the preset pulse on the pixel electrode will be substantially equal for all display elements irrespective of the applied grey levels.

In an embodiment the pixel element is coupled to the control means via a further switching element. The further switching elements enables dividing of the display elements in two or more groups.

These and other aspects of the invention are apparent from and will be elucidated with reference to the embodiments described hereinafter. In the drawings:

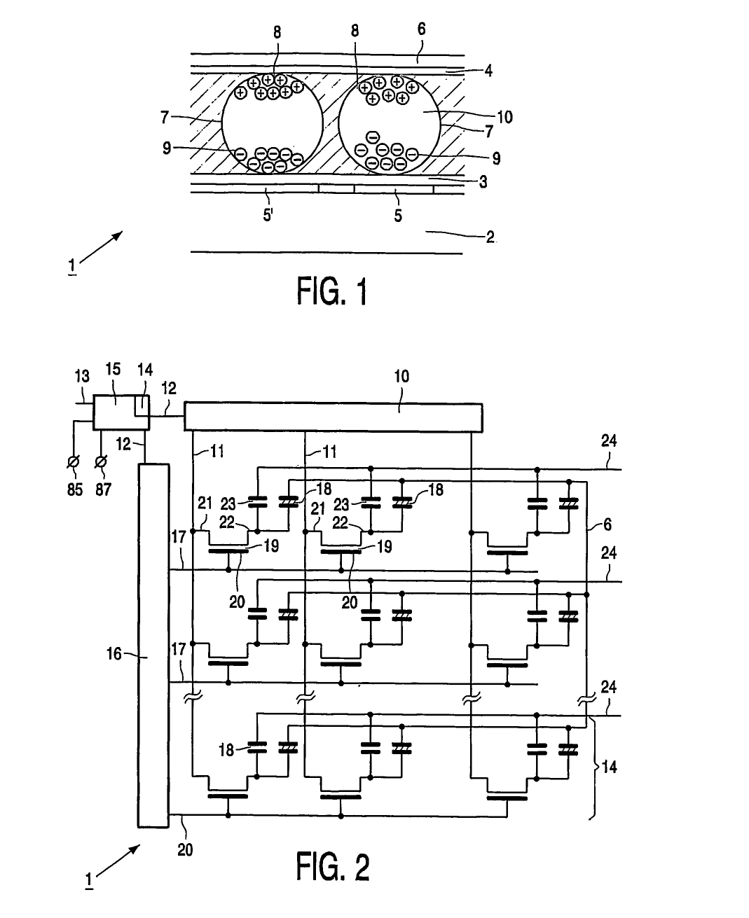

FIG. 1 shows diagrammatically cross-section of a portion of a display device,

FIG. 2 shows diagrammatically an equivalent circuit diagram of a portion of a display device,

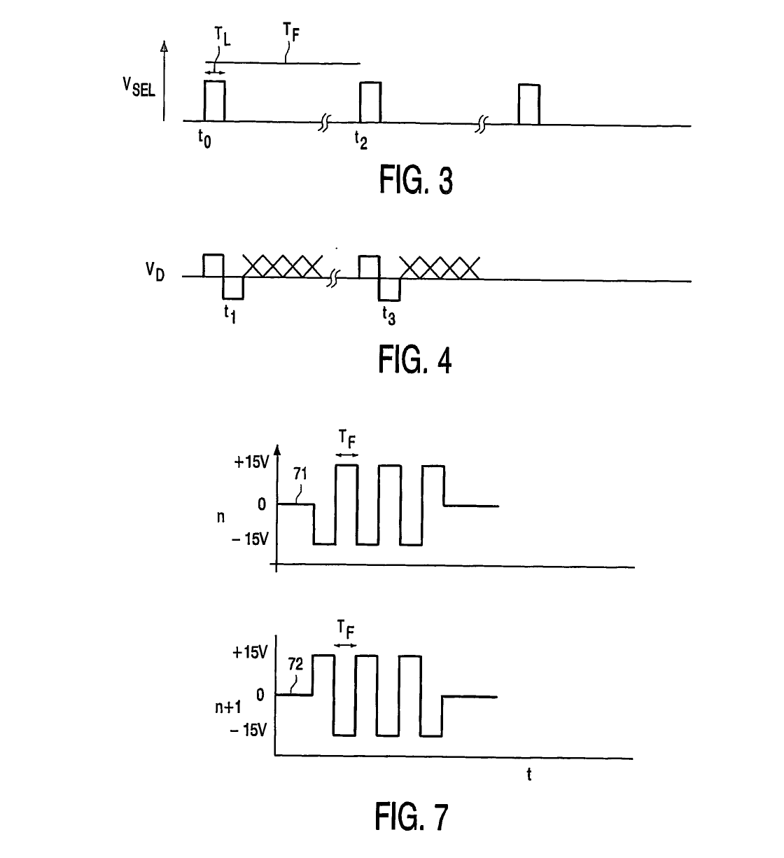

FIGS. 3 and 4 shows drive signals and internal signal of the display device,

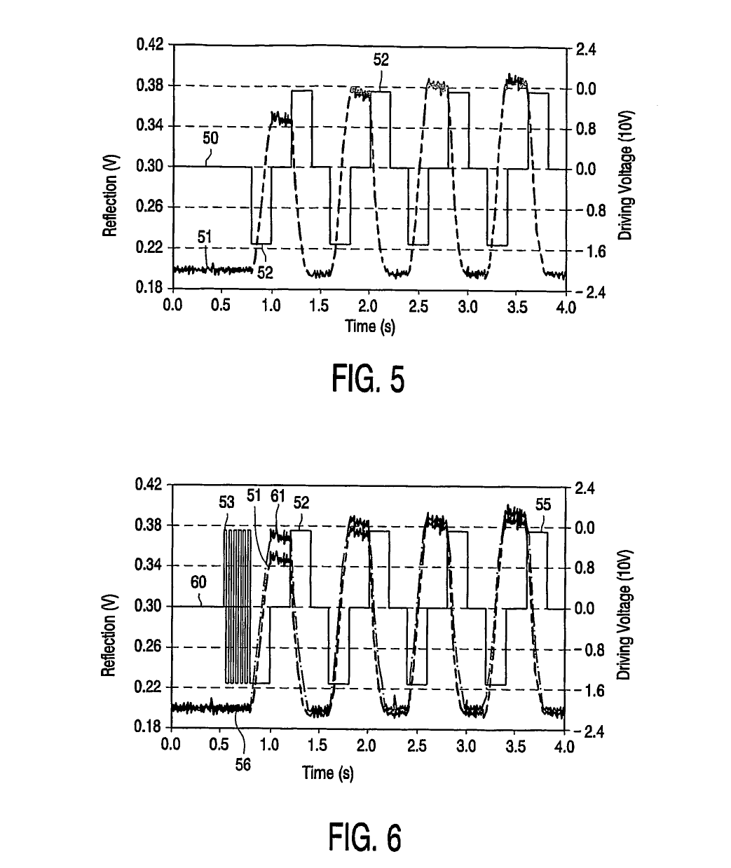

FIG. 5 shows an optical response of a data signal,

FIG. 6 shows an optical response of a preset signal and a data signal

FIG. 7 shows preset signals for pixel electrode for two adjacent rows consisting of 6 pulses of opposite polarities,

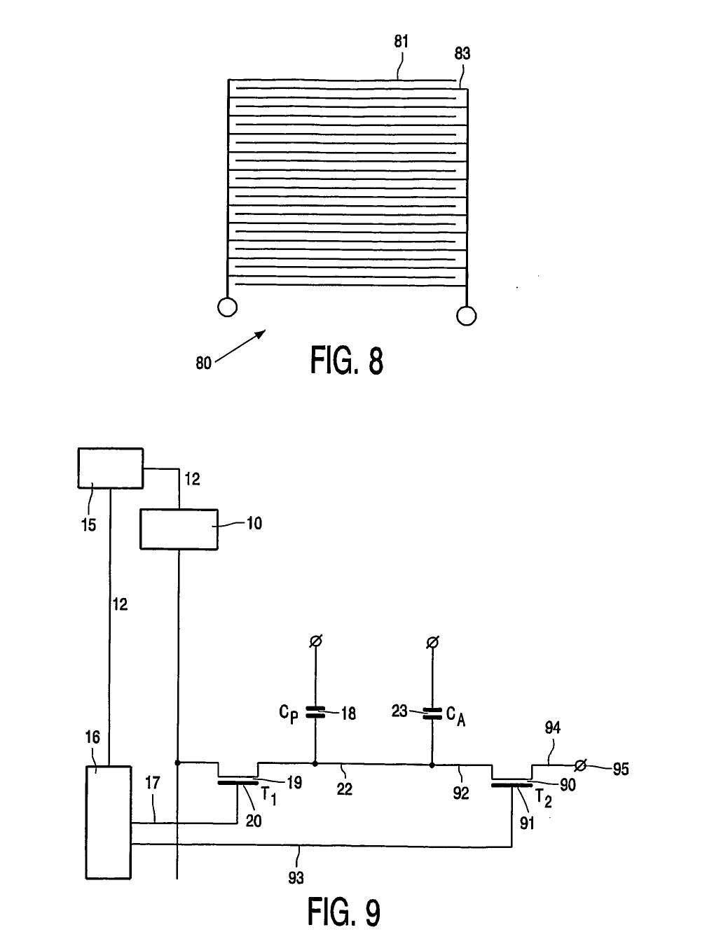

FIG. 8 shows an example of a counter electrode comprising interdigitized comb structures and

FIG. 9 shows an equivalent circuit of a display element with two TFTs.

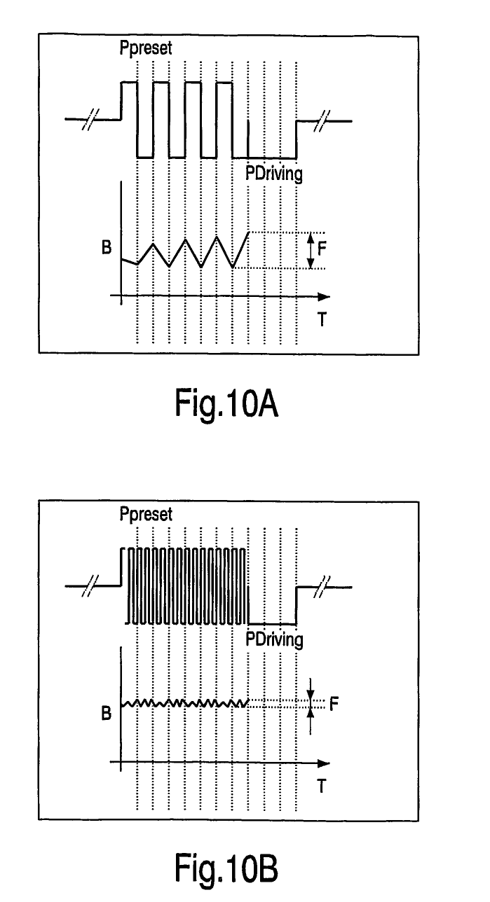

FIG. 10A shows the brightness levels during preset pulses for preset pulses larger than or equal to 20 msec, for a device not in accordance with the invention. FIG. 10B shows the brightness levels during preset pulses for preset pulses shorter than 19 ms, i.e. for device in accordance with the invention

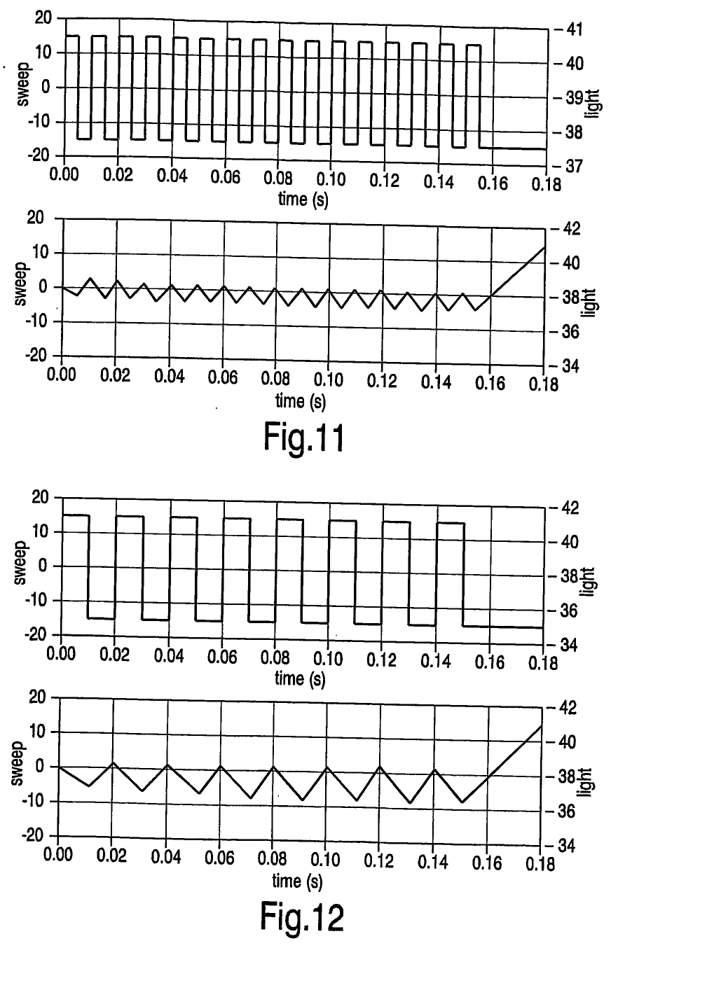

FIG. 11 shows pulses and grey level variations for preset pulses of 5 msec duration.

FIG. 12 shows pulses and grey level variations for preset pulses of 10 msec

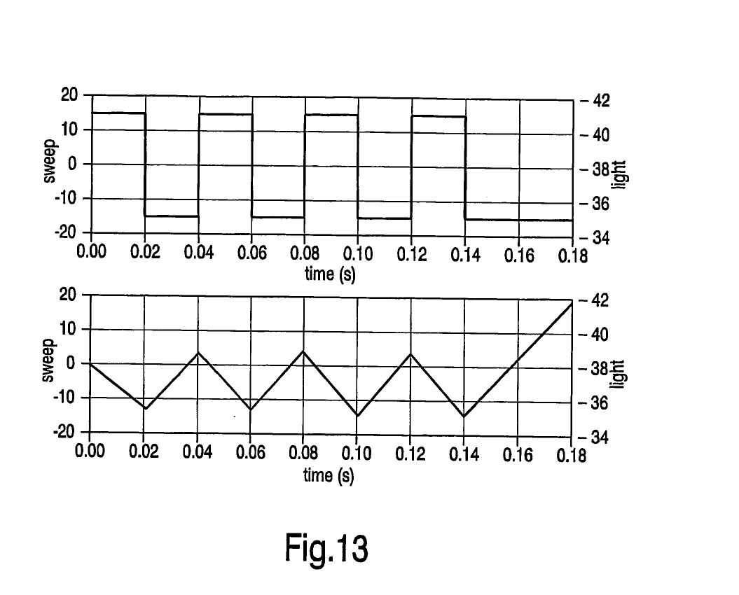

FIG. 13 shows pulses and grey level variations for preset pulses of 20 msec duration.

The Figures are schematic and not drawn to scale, and, in general, like reference numerals refer to like parts.

FIG. 1 diagrammatically shows a cross section of a portion of an electrophoretic display device 1, for example of the size of a few display elements, comprising a base substrate 2, an electrophoretic film with an electronic ink which is present between two transparent substrates 3,4 for example polyethylene, one of the substrates 3 is provided with transparent picture electrodes 5 and the other substrate 4 with a transparent counter electrode 6. The electronic ink comprises multiple micro capsules 7, of about 10 to 50 microns. Each micro capsule 7 comprises positively charged white particles 8 and negative charged black particles 9 suspended in a fluid 10. When a positive pixel voltage VD is applied to the pixel electrodes 5,5′ with respect to the counter electrode 6, an electric field is generated which moves the white particles 8 to the side of the microcapsule 7 directed to the counter electrode 6 and the display element will appear white to a viewer. Simultaneously, the black particles 9 move to the opposite side of the microcapsule 7 where they are hidden from the viewer. By applying a negative pixel voltage VD between the pixel electrodes 5,5′ and the counter electrode 6, the black particles 9 move to the side of the microcapsule 7 directed to the counter electrode 6, and the display element will appear dark to a viewer (not shown). When the electric field is removed the particles 8, 9 remains in the acquired state and the display exhibits a bi-stable character and consumes substantially no power.

FIG. 2 shows diagrammatically an equivalent circuit of a picture display device 1 comprising an electrophoretic film laminated on a base substrate 2 provided with active switching elements, a row driver 16 and a column driver 10. Preferably, a counter electrode 6 is provided on the film comprising the encapsulated electrophoretic ink, but could be alternatively provided on a base substrate in the case of operation using in-plane electric fields. The display device 1 is driven by active switching elements, in this example thin film transistors 19. It comprises a matrix of display elements at the area of crossing of row or selection electrodes 17 and column or data electrodes 11. The row driver 16 consecutively selects the row electrodes 17, while a column driver 10 provides a data signal to the column electrode 11. Preferably, a processor 15 firstly processes incoming data 13 into the data signals. Mutual synchronisation between the column driver 10 and the row driver 16 takes place via drive lines 12. Select signals from the row driver 16 select the pixel electrodes 22 via the thin film transistors 19 whose gate electrodes 20 are electrically connected to the row electrodes 17 and the source electrodes 21 are electrically connected to the column electrodes 11. A data signal present at the column electrode 11 is transferred to the pixel electrode 22 of the display element coupled to the drain electrode via the TFT. In the embodiment, the display device of FIG. 1 also comprises an additional capacitor 23 at the location at each display element 18. In this embodiment, the additional capacitor 23 is connected to one or more storage capacitor lines 24. Instead of TFT other switching elements can be applied such as diodes, MIM's, etc.

FIG. 3 and 4 show drive signals of a conventional display device. At the instance t0, a row electrode 17 is energized by means of a selection signal Vsel (FIG. 1.), while simultaneously data signals Vd are supplied to the column electrodes 11. After a line selection time tL has elapsed, a subsequent row electrode 17 is selected at the instant t1, etc. After some time, for example, a field time or frame time, usually 16.7 msec or 20 msec, said row electrode 17 is energized again at instant t2 by means of a selection signal Vsel, while simultaneously the data signals Vd are presented to the column electrode 11, in case of an unchanged picture. After a selection time tL has elapsed, the next row electrode is selected at the instant t3. This is repeated from instant t4. Because the bistable character of the display device, the electrophoretic particles remains in their selected state and the repetition of data signals can be halted after several frame times when the desired grey level is obtained. Usually, the image update time is several frames.

FIG. 5 shows a first signal 51 representing an optical response of a display element of the display device of FIG. 2. on a data signal 50 comprises pulses of alternating polarity after a dwell period of several seconds. In FIG. 5 the optical response 51 is indicated by ---- and the data signal by______. Each pulse 52 of the data signal 50 has a duration of 200 ms and a voltage of alternating plus and minus 15 V. FIG. 5 shows that the optical response 51 after the first negative pulse 52 is not a desired grey level, which is obtained only after the third or fourth negative pulse.

In order to improve the accuracy of the desired grey level with the data signal the processor 15 generates a single preset pulse or a series of preset pulses before the data pulses of a next refresh field, where the pulse time is typically 5 to 10 times less than the interval between an image update and a next subsequent image update. In case the interval between two image updates is 200 ms. The duration of a preset pulse is typically 20 ms.

FIG. 6 shows the optical response of a data signal 60 of the display device of FIG. 2 as a response of a series of 12 preset pulses of short duration and data pulses of 200 ms having a voltage of alternating polarity of plus and minus 15 V. In FIG. 6 the optical response 51 is indicated by ----, the improved optical response 61 by -.-.-.-.- and the data signal by ______. The series of preset pulses consists of 12 pulses of alternating polarity. The voltage of each pulse is plus or minus 15 V. FIG. 6 shows an significant increase of the grey scale accuracy, the optical response 61 is substantially at an equal level as the optical response after the fourth data pulse 55. However, some flicker may become visible introduced by the preset pulses, see optical response 56. In order to reduce the visibility of this flicker, the processor 15 and the row driver 16 can be arranged such that the row electrodes 17 associated with display elements are interconnected in two groups, and the processor 15 and the column driver 10 are arranged for executing an inversion scheme by generating a first preset signal having a first phase to the first group of display elements and a second preset signal having a second phase to the second group of display element, whereby the second phase is opposite to the first phase. Alternatively, multiple groups can be defined, whereto preset pulses are supplied with different phases. For example, the row electrodes 17 can be interconnected in two groups one of the even rows and one group of the odd row whereby the processor generates a first preset signal consisting of six preset pulses of alternating polarity of plus and minus 15 V starting with a negative pulse to the display elements of the even rows and a second preset signal consists of six preset pulses of alternating polarity of plus and minus 15 V starting with a positive pulse to display elements of the odd rows.

FIG. 7 shows two graphs indicative for an inversion scheme. A first graph 71 relates to a first preset signal consisting of 6 preset pulses of 20 ms supplied to a display element of an even row n and a second graph 72 related to a second preset signal consisting of 6 preset pulses of 20 ms supplied to a display element of an odd row n+1, whereby the phase of the second preset signal is opposite the phase of the first preset signal. The voltage of the pulse is alternating between plus and minus 15 V.

Instead of the series of preset pulses applied to two or more different groups of rows, the display elements can be divided in two groups of columns, for example, one group of even columns and one group of odd columns whereby the processor 15 executes an inversion scheme by generating a first preset signal consisting of six preset pulses of alternating polarity of plus and minus 15 V starting with a negative pulse to the display elements of the even columns and a second preset signal consists of six preset pulses of alternating polarity of plus and minus 15 V starting with a positive pulse to the display elements of the odd columns. Here, all rows can be selected simultaneously. In further embodiments, inversion schemes as just discussed can be simultaneously supplied to both rows and columns to generate a so called dot-inversion scheme, which still further reduces optical flicker.

In a further embodiment the counter electrode 80 is shaped as two interdigitized comb structures 81,83 as shown in FIG. 8 in order to reduce optical flicker. This kind of electrode is well known to the skilled person. The two counter electrodes 81,83 are coupled to two outputs 85,87 of the processor 15. Furthermore, the processor 15 is arranged for generating an inversion scheme by supplying a first preset signal consisting of six preset pulses of 20 ms and alternating polarity of plus and minus 15 V starting with a negative pulse to the first comb structure 81 and a second preset signal consisting of six preset pulses of 20 ms of alternating polarity of plus and minus 15 V starting with a positive pulse to the to the second comb structure 83, whilst holding the pixel electrode 23 at 0 V. After the preset pulses are supplied the two comb structures 81,83 can be connected to each other before new data is supplied to display device.

In a further embodiment, the preset pulses can be applied by the processor 15 via the additional storage capacitors 23 by charge sharing between the additional storage capacitor 23 and the pixel capacitance 18. In this embodiment, the storage capacitors on a row of display element are connected to each other via a storage capacitor line and the row driver 16 is arranged to interconnect these storage capacitor lines to each other in two groups enabling inversion of the preset pulses over two groups, a first group related to ever rows of display elements and a second group related to odd rows of picture elements. In order to improve grey scale reproduction before new data is supplied to the display element, the row driver executes an inversion scheme by generating a first preset signal consisting of 6 preset pulses of alternating polarity to the first group and a second preset signal consisting of 6 preset pulses of alternating polarity to the second group whereby the phase of the second signal is opposite the phase of the first signal. After the preset pulses are supplied to the display elements, the storage capacitors can be grounded before the new data is supplied to the display elements.

In a next further embodiment, the preset pulses can be applied directly to the pixel electrode 22 by the processor 15 via an additional thin film transistor 90 coupled via its source 94 to a dedicated preset pulse line 95 as shown in FIG. 9. The drain 92 is coupled to the pixel electrode 22. The gate 91 via a separate preset pulse addressing line 93 to the row driver 16. The addressing TFT 19 must be non-conducting by, for example, setting the row electrode 17 to 0 V.

When the preset signal is applied to all display elements simultaneously flicker may occur. Therefore, preset signal inversion is applied by division of the additional thin film transistors 90 in two groups, one group connected with display elements of even rows and one group connected with display elements of odd rows. Both groups of TFT's 90 are separately addressable and connected to the preset pulse lines 95. The processor 15 executes an inversion scheme by generating a first preset signal consisting of, for example, 6 preset pulses of 20 ms and a voltage 15 V with alternating polarity to the first group of TFT's 90 via the preset pulse line 95 and a second preset signal consisting of 6 preset pulses of 20 ms and a voltage of 20 ms and alternating polarity to the second groups of TFT's 90 whereby the phase of the second signal is opposite the phase of the first signal. Alternatively, a single set of TFT's addressable in the same time can be attached to two separate preset pulse lines with inverted pre set pulses.

After the preset signal are supplied to the TFT's 90, the TFT's are deactivated before new data is supplied via the column drivers 10.

Furthermore, further power reductions are possible in the described embodiments by applying any of the well-known charge recycling techniques to the (inverted) preset pulse sequences to reduce the power used to charge and discharge pixel electrodes during the preset pulse cycles.

The inventors have realized that the duration of the preset pulses has a surprising effect on the grey level, more in particular the grey level shows variations which may become visible as flicker by the viewer. Therefore, within the concept of the invention the duration of the preset pulse is kept below 19 msec.

A preset pulse or a series of preset pulses with a pulse length (duration) of less than 19 ms are used. The optical disturbance (flicker) is massively reduced whilst the effects of dwell time and image history are minimized. It is particularly important to reduce/avoid flickers induced by a preset pulse when preset pulses are simultaneously loaded on the whole display panel, ie. when the display as a whole is simultaneously preset and the preset pulses are in phase. The flicker then occurs over the whole display and may become very visible.

FIG. 10A illustrates an example of a device/driving a device not in accordance with this aspect of the invention, i.e. a device is which low frequency (duration longer than 20 msec) preset pulses are applied. This leads to a significant optical flicker F. The figure shows the brightness B as a function of time T, and the applied preset pulses. This figure also shows that during a series of preset pulses Ppreset the amplitude of the flicker F grows. FIG. 10B illustrate a device driven in accordance with this aspect of the invention, i.e. using high frequency preset pulses Ppreset (duration less than 19 msec, preferably even less) in which the optical flicker F is reduced as can be seen by comparing flicker F shown in FIG. 10A with that of FIG. 10B. By using a preset pulse of less than 19 msec, the grey level fluctuations (flicker F) are kept relatively small.

Within the concept of the invention it is possible that a set of preset pulses is applied and that some preset pulses, in particular the first or first few of a set of preset pulses are longer than 19 msec. As FIG. 10A shows the flicker level grows during the series of preset pulses. The grey scale variation effect increases, when a set of preset pulses is used, as more pulses are given, i.e. the effect is stronger for the second pulse than for the first, for the third stronger than for the second etc. Therefore, within the broader concept of the invention some earlier pulses of a series of preset pulses may be longer than 19 msec.

FIGS. 11 to 13 illustrate various embodiment of a device. FIG. 11 illustrate a device in which in operation preset pulses of duration 5 msec are used. The experimental results are shown in FIG. 11, in which the top half of the figure gives the waveform of preset pulses and the bottom half the corresponding optical response, expressed in units of lightness L*, at the dark grey state (brightness 38L*). The maximum flicker (peak-to-peak) is less than 1L*, which means that these flickers are not visually visible during image update. Further experiments demonstrated that accurate greyscales are obtained and the effect of dwell time and image history is minimized. FIG. 12 illustrates the situation when preset pulses with a pulse length of 10 ms are used. The experimental results are shown in FIG. 12, in which the top half of the figure gives the waveform of the preset pulses used and the bottom half of the figure the corresponding optical response at the dark grey state (brightness 37L*). The maximum flicker (peak-to-peak) is about 2L*, which means that these flickers are still not visually visible during image update. Further experiments demonstrated that accurate greyscales are obtained and the effect of dwell time and image history is minimized.

Finally FIG. 13 illustrates a device in which preset pulses having a duration of 20 msec are used. The total time period for the shaking pulses is also 160 ms. The maximum flicker (peak-to-peak) is now about 4L*, which is visually visible during image update. Further experiments demonstrated that the accuracy of the obtained greyscales is similar to that achieved according to the embodiments of FIGS. 11 and 12.

Preferably the preset pulses are longer than 0.5 msec. The preset pulses are meant to “shake up” the electrophoretic particles, when the length of the preset pulses decreases to smaller than 0.5 msec, the height of the preset voltage pulse has to be increased to a level that is difficult to obtain and sustain. Also as the pulse width decreases the energy consumption increases. Preferably the preset pulse width lies between 1 and 15 msec, most preferebaly between 2 and 10, even more preferably between 3 and 5 msec. The inventors have realized that a balance is best stuck between on the one hand the power requirement (as the pulse width decreases the power required increases), and the pulse height (as the pulse width decreases the pulse height increases) and on the other hand the optical effect (as the pulse width decreases the grey level variations decrease). Depending on the circumstances an optimum is obtained between 1 and 15 msec, where the best choice lies between 2 and 10, best between 3 and 5 msec. Without being bound by any theoretical explanation it is believed that a possible explanation of the effect of the pulse length of the preset pulses on the grey level fluctuations may be as follows:

The influence of dwell time and image history can be effectively reduced by using a series of preset pulses with a pulse length of less than 19 msec, preferably around 3-5 ms. The corresponding optical flickers are minimized to less than 2L*-1L*. Apparently, the energy involved in such a short preset pulse is sufficient to release the opposite ions surrounding the particles but insufficient to move the particles for a large distance, indicated by the low flicker.

In short the invention can be described as follows:

A display device comprises electrophoretic particles, a display element comprising a pixel electrode and a counter electrode between which a portion of the electrophoretic particles are present and a controller for supplying a drive signal to the electrodes to bring the display element in a predetermined black or white state, corresponding to the image information to be displayed. In order to improve the refresh time of the display, the controller is further arranged for supplying a preset signal preceding the drive signal comprising a preset pulse having an energy sufficient to release the electrophoretic particles at a first position near one of the two electrodes corresponding to a black state, but too low to enable the particles to reach a second position near the other electrode corresponding to a white state. The duration of the preset pulses is less than 19 msec, preferably between 1 and 10 msec. Setting the duration of the preset pulses to less than 19 msec reduced visible flicker F.

It will be obvious that many variations are possible within the scope of the invention without departing from the scope of the appended claims.

1. A display device comprising electrophoretic particles, a display element comprising a pixel electrode and a counter electrode between which a portion of the electrophoretic particles are present, and control means for supplying a drive signal to the electrodes to bring the display element in a predetermined optical state corresponding to the image information to be displayed, characterized in that control means are further arranged for supplying a preset signal preceding the drive signal comprising a preset pulse having an energy sufficient to release the electrophoretic particles at a first position near one of the two electrodes corresponding to a first optical state, but too low to enable the particles to reach a second position near the other electrode corresponding to a second optical state, wherein the duration of the preset pulse is less than 19 msec.

2. A display device as claimed in claim 1, wherein the control means are arranged for supplying a set of preset pulse, wherein the duration of the majority, preferably all, of the preset pulses is less than 19 msec.

3. A display device as claimed in claim 1, wherein the duration of the preset pulse or pulses is more than 0.5 msec.

4. A display device as claimed in claim 1, wherein the duration of the preset pulse or preset pulses lies between 1 and 15 msec.

5. A display device as claimed in claim 4, wherein the duration of the preset pulse or preset pulses lies between 2 and 10 msec.

6. A display device as claimed in claim 5, wherein the duration of the preset pulse or preset pulse lies between 3 and 5 msec.

7. A display device as claimed in claim 1, wherein the control means being further arranged for generating the preset pulse with a negative or positive polarity and the control means being further arranged for generating the drive signal comprising a pulse with a negative or positive polarity, whereby the polarity of the preset pulse is opposite to the polarity of the pulse of the data signal.

8. A display device as claimed in claim 7 wherein the control means being further arranged for generating an even number of preset pulses.

9. A display device as claimed in claim 1 wherein one of the electrodes comprises a data electrode and the other electrode comprises a selection electrode and the control means further comprising first drive means for applying a selection signal to the selection electrodes and second drive means for applying a data signal to the data electrode.

10. A display device as claimed in claim 1 wherein the pixel electrode of the display element is being coupled to a selection electrode or a data electrode via a switching element, and the control means further comprising first drive means for applying a selection signal to the selection electrodes and second drive means for applying a data signal to the data electrode.

11. A display device as claimed in claim 9, wherein selection electrodes associated with display elements are interconnected in two groups, and the control means being arranged for generating a first preset signal having a first phase to the first group and a second preset signal to the second group having a second phase opposite to the first phase.

12. A display device as claimed in claim 9, wherein the second drive means are arranged for generating the preset signal.

13. A display device as claimed in claim 9, wherein the pixel electrode is coupled to the control means for generation of the preset signal via the counter electrode.

14. A display device as claimed in claim 13, wherein the counter electrode is divided into two portions, wherein each portion is associated with a set of display elements connected via a selection electrode.

15. A display device as claimed in claim 10, wherein the pixel electrode is coupled via a first additional capacitive element to the control means for receiving the preset signal.

16. A display device as claimed in claim 10, wherein the pixel electrode is being coupled to the control means via a further switching element.

17. A display device as claimed in claim 1, wherein the display comprises two substrates one of which is transparent and the electrophoretic particles are present between the two substrates.

18. A display device as claimed in claim 1, wherein the electrophoretic material is an encapsulated electrophoretic material.
